(19) United States
(12) Patent Application Publication
(10) Pub. No.: US 2013/0222565 A1
(43) Pub. Date: Aug. 29, 2013

(54) System and Method for Sensor Fusion of Single Range Camera Data and Inertial Measurement for Motion Capture

(71) Applicant: The Johns Hopkins University, (US)

(72) Inventors: Kelleher Riccio Guerin, Baltimore, MD (US); Allison Okamura, Mountain View, CA (US); Michele Rotella, Menlo Park, CA (US); Xingchi He, Baltimore, MD (US); Jonathan Bohren, Baltimore, MD (US)

(73) Assignee: THE JOHNS HOPKINS UNIVERSITY, Baltimore, MD (US)

(21) Appl. No.: 13/780,252

(22) Filed: Feb. 28, 2013

Related U.S. Application Data
(60) Provisional application No. 61/604,244, filed on Feb. 28, 2012.

(51) Int. Cl. H04N 7/18

(52) U.S. Cl. CPC H04N 7/18
USPC 348/77

(57) ABSTRACT

An embodiment in accordance with the present invention provides a motion capture system that can be coupled with a feedback system. The system can be used for collecting motion capture data about a user's position and/or movement and comparing that data to an exemplary position or movement to determine errors in the position or movement. The system can include a single range camera to provide color and depth data as well as inertial sensors to provide inertial measurements. Additionally, the system can provide feedback to the user to encourage correction of the errors the system finds with respect to the user's position and/or movement.

### CROSS REFERENCE TO RELATED APPLICATIONS

This application claims the benefit of U.S. Provisional Patent Application No. 61/604,244 filed Feb. 28, 2012, which is incorporated by reference herein, in its entirety.

### FIELD OF THE INVENTION

The present invention relates generally to motion capture. More particularly, the present invention relates to a system and method for gathering and processing motion capture data.

### BACKGROUND OF THE INVENTION

Motion capture technology has been used for some time to generate data and images based on a user's body position and movement. More recently, this same motion capture technology has been combined with feedback systems to provide the user with position and movement correction.

Work in the area of motion guidance can include a range of motion capture and feedback methods and displays. However, many of these systems can be cumbersome, complicated to use, and prohibitively expensive for widespread use. In one example, a full-body vibrotactile display for correcting posture in sports uses spatial cues activated remotely by an instructor. In another example, a tactile sleeve for collision avoidance and skill training in virtual environments, uses infrared motion capture, and in another a wearable jacket with vibration motors for correcting posture and violin bowing technique uses inertial motion capture.

More particularly, one example includes an upper-body suit with voice coil actuators for vibrotactile feedback for 5-DOF motion of the arm. Using an optical tracking system, a user's motion was compared to the desired trajectory of a teacher and vibrotactile feedback proportional to joint error was delivered simultaneously to the wrist, elbow, and shoulder to help the user mimic the teacher's motion. Sensory saltation, requiring a sequence of spatially and temporally specific vibration pulses, signaled joint rotation. In a motor task, it was found that tactile feedback improved performance by 27%, most significantly at flexion joints of wrist and elbow, and further, improved task learning by 23%.

In another of the examples, the system was focused on regulating the orientation of the forearm in Cartesian space, using a magnetic tracking system. Tactile feedback was delivered to the wrist via an instrumented bracelet with four motors oriented in quadrants. Vibration proportional to error was delivered in the direction of suggested movement. In the task of 2-DOF forearm orientation, a combination of visual and tactile feedback was found to be most effective, where the former dominated the initial trajectory and the latter corrected small-scale positioning error.

In another example, the spatially distributed tactile feedback sleeve incorporated sensing via a magnetic system and delivered feedback to 4 DOF of the arm. Eccentric mass motors provided localized, repulsive vibration that “pushed” users towards the correct posture or motion trajectory. Vibrational amplitude was proportional to errors in joint space and an angular tolerance dictated the acceptable joint regions. This system targeted apraxic stroke patients who may benefit from haptic versus visual stimuli in virtual reality interaction.

It would therefore be advantageous to provide a system and method that would gather motion capture data and provide feedback to the user in a cost effective manner.

### SUMMARY OF THE INVENTION

The foregoing needs are met, to a great extent, by the present invention, wherein in one aspect depth imaging data from a single range camera is analyzed in conjunction with data from inertial sensors to capture a user's position with six degrees-of-freedom, wherein three degrees-of-freedom are captured from the position and three degrees-of-freedom are captured from the orientation.

In accordance with one aspect of the present invention, a system for motion capture of a user includes a single range camera configured to collect depth and color data and inertial sensors configured to collect inertial motion data. The system can also include a computer readable medium configured to analyze data from the single range camera and the inertial sensors in order to determine a position of the user.

In accordance with another aspect of the present invention, the computer can be programmed to compare the position of the user to data for an exemplary position or motion. The data for an exemplary position can include data from a teacher also using the system for motion capture and predetermined data for the exemplary position stored on a computer readable medium. Additionally, the computer can be programmed to provide a calculation of the error between the position of the user and the data for the exemplary position. The system can also include a device for providing feedback to the user to correct the error between the position or motion of the user and the data for the exemplary position or motion, and the device for providing feedback to the user can include feedback in the form of at least one of the following: visual feedback, tactile feedback, vibrotactile feedback, and sound feedback.

In accordance with yet another aspect of the present invention, the system for motion capture can include an eccentric mass motor for providing feedback to the user. The inertial sensor takes the form of an accelerometer, and more particularly the accelerometer further takes the form of a 3-axis accelerometer. The inertial sensor is positioned on a body part of the user for which it is to collect inertial motion data. Specifically, the inertial sensors are positioned to collect inertial motion data for a whole body of the user, and can be mounted in bands to allow the inertial sensors to be secured to the user. The inertial sensors are further positioned at a distal-most point of a limb-segment of the user. The system for motion capture can also include a visual display. The visual display is further configured to show the user a visual representation of the user's movement and configured to show the user a visual representation of the user's movement relative to an exemplary movement. Additionally, the system for motion capture includes a microcontroller. The microcontroller is configured to control the inertial sensors as well as feedback to the user.

In accordance with another aspect of the present invention, a method for motion capture of a user includes collecting data related to the user's motion using a single range camera and collecting inertial motion data for the user's motion. The method also includes analyzing the data from the single range camera and the inertial motion data in order to determine a position of the user.

In accordance with yet another aspect of the present invention, the method further includes comparing the position of the user to data for an exemplary position. The methods also includes calculating error between the position of the user and the data for the exemplary position. Additionally, the method includes providing feedback to the user to correct the error between the position of the user and the data for the exemplary position and providing visual feedback to the user.

### BRIEF DESCRIPTION OF THE DRAWINGS

FIG. 1 illustrates a user of the system maintaining a static pose with the assistance of the feedback provided by the system and based on the motion capture data collected by the system, in accordance with an embodiment of the invention.

FIG. 2 illustrates a diagram of a system for gathering and analyzing motion capture data and providing user feedback, in accordance with an embodiment of the invention.

FIG. 3 illustrates a graph plotting acceleration over time for a single tactor response to a binary control signal, in accordance with an embodiment of the invention.

FIG. 4A illustrates an exemplary schematic of an armband for producing a vibrotactile feedback pattern for a user's joint misalignment about the Z-axis, in accordance with an embodiment of the invention.

FIG. 4B illustrates an exemplary schematic of an armband for producing a vibrotactile feedback pattern for a user's joint misalignment about both the X-axis and the Y-axis, in accordance with an embodiment of the invention.

FIG. 4C illustrates an exemplary schematic of an armband for producing a vibrotactile feedback pattern for a user's joint misalignment about a single axis, the Y-axis, in accordance with an embodiment of the invention.

FIG. 5 illustrates a chart of numbered haptic feedback activations across four joints ordered over time, in accordance with an embodiment of the invention.

FIG. 6 illustrates a user wearing the motion capture and feedback bands in accordance with an embodiment of the invention.

FIG. 7A illustrates a diagram of a neutral position superimposed with a diagram of a simulated motion for a lateral torso bend.

FIG. 7B illustrates a diagram of a neutral position superimposed with a diagram of a simulated motion for a torso twist.

FIG. 7C illustrates a diagram of a neutral position superimposed with a diagram of a simulated motion for an arm raise.

FIG. 7D illustrates a diagram of a simulated motion for a forearm rotation.

FIG. 8 illustrates a graph of kinetic error in angular position sensing for the torso, shoulder and elbow, in accordance with an embodiment of the invention.

FIG. 9A illustrates a graph of average error and point error for a lateral torso bend across feedback conditions including: no feedback, visual feedback, and haptic feedback in accordance with an embodiment of the invention.

FIG. 9B illustrates a graph of average error and point error for a torso rotation across feedback conditions including: no feedback, visual feedback, and haptic feedback in accordance with an embodiment of the invention.

FIG. 9C illustrates a graph of average error and point error for an arm raise in both dominant and non-dominant arms across feedback conditions including: no feedback, visual feedback, and haptic feedback.

FIG. 9D illustrates a graph of average error and point error for forearm rotation in both dominant and non-dominant arms across feedback conditions including: no feedback, visual feedback, and haptic feedback.

### DETAILED DESCRIPTION

The invention will now be described with reference to the drawing figures, in which like reference numerals refer to like parts throughout. An embodiment in accordance with the present invention provides a motion capture system that can be coupled with a feedback system. The system can be used for collecting motion capture data about a user's position and/or movement and comparing that data to an exemplary position or movement to determine errors in the position or movement. The system can include a single range camera to provide color and depth data coupled with inertial sensors to provide inertial measurements. Additionally, the system can provide feedback to the user to encourage correction of the errors the system finds with respect to the user's position and/or movement.

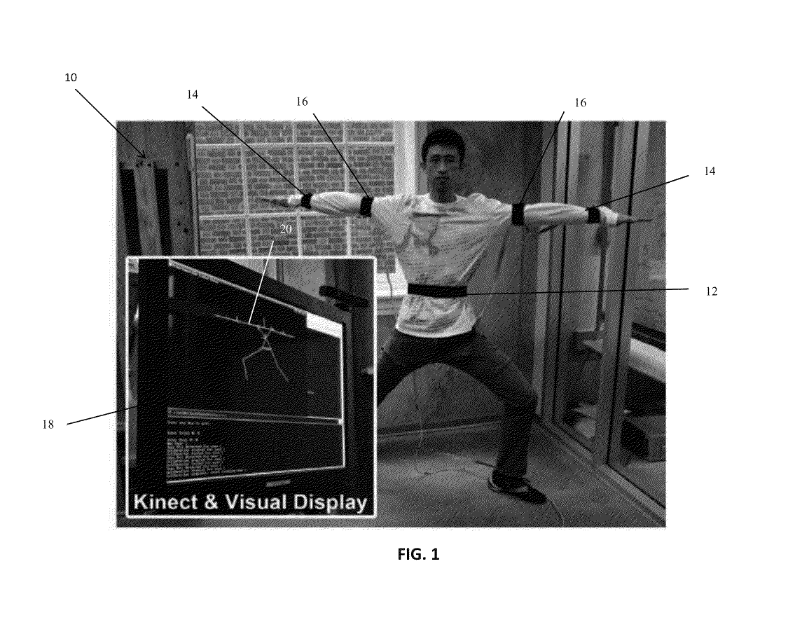

FIG. 1 illustrates a user of the system maintaining a static pose with the assistance of the feedback provided by the system and based on the motion capture data collected by the system, in accordance with an embodiment of the invention. As illustrated in FIG. 1, an exemplary system 10 can include five bands worn around the torso 12, lower arms 14, and upper arms 16 for correcting 15-DOFs of the upper-body. However, this placement of the bands should not be considered limiting, as this system can be expanded to a full-body feedback system. The system 10 is also modular, and each of the bands 12, 14, 16 can be configured to contain inertial sensors to provide data with respect to inertial movements and eccentric mass motors to deliver feedback to the joints. Error in joint position can be corrected within a single joint at a time, and a modified saltation signal is implemented, along with constant amplitude pulsation, to reduce attentional demand of the user. An algorithm, which will be explained in further detail below, can be used to fuse the three degree-of-freedom single range camera position sensing with body-mounted inertial sensors to fully determine limb position and orientation with six degrees-of-freedom.

FIG. 1 also illustrates a view of the visual display 18 showing an image of the position of the user as determined by input from the single range camera and the inertial sensor. More particularly, the visual display 18 can be on an external screen and shows a skeleton 20 that represents the user's pose. The external screen can also show coordinate frames indicating the orientation of the upper body joints from which the bands are transmitting. It should be noted that the visual display 18 can take any form suitable for displaying the user's image and other coordinates. The visual display 18 also does not have to take the form of a stand-alone component, such as the external screen, and could alternately be incorporated into one of the other components of the system.

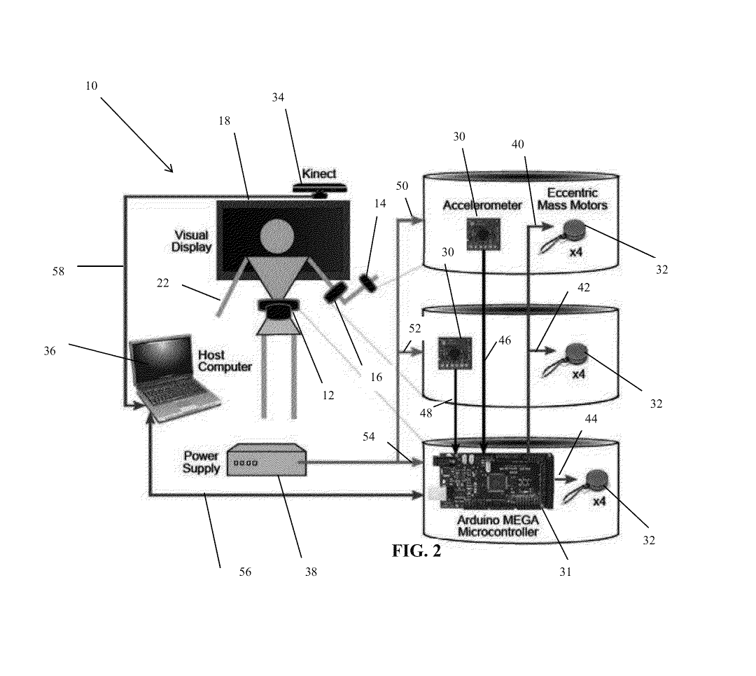

FIG. 2 illustrates a diagram of a system for gathering and analyzing motion capture data and providing user feedback, in accordance with an embodiment of the invention. FIG. 2 illustrates the system 10 and a user 22 of the system 10 facing the visual display 18. The user 22 is wearing bands 12, 14, and 16. Band 12 is worn around the user's waist 24, while bands 14 and 16 are worn around the user's forearm and upper arm, respectively. As illustrated, the arm bands are preferably positioned at the distal-most limb locations, i.e. above the elbow and at the wrist, to optimize sensing of arm rotation. Each of the bands 12, 14, and 16 can be formed from a two-inch wide elastic material with a hook and loop fastener to allow for size adjustment. However, any suitable material and/or adjustable closure device can be used to create the bands.

As illustrated in FIG. 2, the bands 12, 14, and 16 can be used both for sensing motion and also for providing feedback to the user 22. In order to sense the user's 22 arm and torso motion, the bands 12, 14, and 16 contain inertial sensors 30, such as inertial sensors, gyros, or other devices to provide inertial feedback. In the exemplary embodiment, shown in FIG. 2, the system includes one inertial sensor 30 per band 12, 14, and 16 in order to generate data related to the user's 22 inertial movements. While the exemplary system of FIG. 2 illustrates the use of one inertial sensor 30 per band 12, 14, and 16, this is not intended to be limiting, and any suitable number of inertial sensors could be used. Preferably, if an accelerometer is used, the accelerometer takes the form of a small, thin, low power, complete 3-axis accelerometers with signal conditioned voltage outputs. The proposed accelerometers can measure acceleration with a minimum full-scale range of ±3 g, and can measure the static acceleration of gravity in tilt-sensing applications, as well as dynamic acceleration resulting from motion, shock, or vibration.

Also illustrated in FIG. 2, each of the bands 12, 14, and 16 can also include eccentric mass motors 32 to provide vibrotactile feedback to the user 22. The waistband 12 provides feedback to stabilize the core and the arm bands 14 and 16 provide motion cues to position the shoulder and elbow joints. As shown in FIG. 2, the bands, 12, 14, and 16 can include four eccentric mass motors 32 each. While this exemplary embodiment uses four eccentric mass motors 32 per band 12, 14, and 16, any suitable number of eccentric mass motors 32 could be used to provide the user 22 with vibrotactile feedback. Additionally, other devices that provide feedback can be used, such as sound generators and other sources of tactile feedback. The eccentric mass motors 32 can be mounted on the bands 12, 14, 16 using moveable loop and hook fasteners to allow for tight, yet customizable placement of the motors 32 against the skin.

Additionally, as illustrated in FIG. 2, the system 10 can include a single range camera 34 used to capture three-dimensional joint position data, with three degrees-of-freedom, as well as, color and depth data. Preferably, the single range camera 34 can take the form of a Kinect™ (Microsoft, Inc., Redmond, Wash.). However, any single range camera that can provide three-dimensional joint position data, with three degrees-of-freedom, as well as color and depth data can be used. The single range camera 34 is an RGB camera that can provide an 8-bit color image of a scene and includes a depth sensor to provide and 11-bit depth image, using protection of an infrared light pattern and time-of-flight measurement. Preferably, the camera 34 can have a resolution of 640×480 pixels, and record at a rate of 30 frames per second. Also, the camera 34 can have a sensor with a useable workspace range of 1.2 m-3.5 m in depth and a sensing resolution in a range of approximately 3 mm in the X-Y plane and 1 cm in the Z plane with the user at a distance of 2 m from the sensor.

Also, as illustrated in FIG. 2, the system 10 can include a microcontroller 31 mounted in the waist band 12. The microcontroller 31 controls motor activation 40, 42, 44 and reads inertial sensor data 46, 48. Preferably, communication between a host computer 36 and the microcontroller 31 is carried out via a custom serial protocol across a USB connection. Alternately, the communication between the host computer 36 and the microcontroller 31 can be carried out wirelessly. The microcontroller 31 reads the analog output of the arm inertial sensors and controls the eccentric mass motors 32 on the waist 12 and arm bands 14, 16.

As illustrated in FIG. 2 the system 10 includes the host computer 36, which is used to process the data from the single range camera 34 and the inertial sensors 30, transmitted via the microcontroller 31, for the system for motion capture and feedback. The host computer 36 includes implementation software that compares the user's 22 position to that of an exemplary pose or of a teacher. For example, the implementation software can include a driver package for the single range camera 34 using a C++ framework. The software can also include middleware which provides 15 joint positions in the reference frame of the single range camera. Using this position data a skeleton of the user 22 can be built. To mitigate the effects of low sensor resolution and noise, a low-pass filter was applied to smooth joint position data, using a simple moving average.

The data from the inertial sensors 30, transmitted by the microcontroller 31, is also processed by the host computer illustrated in FIG. 2. It is assumed that the measured acceleration is gravity, because user motion while maintaining a static position is relatively slow. The inertial sensor data therefore, represents the projection of gravity on the inertial sensor axes. The software can convert voltage data from the inertial sensors 30 into angles about X, Y, and Z joint axes and applied a low-pass filter. For a slow movement situation, a cutoff frequency of 1.6 Hz was implemented to preserve low-frequency user motion and attenuated high frequency motor vibration and noise. To synchronize the sampling of the single range camera 34 and inertial sensor 30 at different rates, the latest inertial sensor 30 readings were acquired each time the software generated a new frame depicting the user's skeleton. Connection arrows 50, 52, 54 show power distribution from an external supply 38, and connection arrows 56 and 58 represent USB communication between the single range camera 34, the computer 36, and the microcontroller 31. These connections 50, 52, 54, 56, and 58 could also be executed wirelessly. The host computer 36 also executes the algorithm for determining the joint position and the error between the user's 22 position and the exemplary position. This algorithm will be described in further detail below.

Complete 6-DOF joint sensing was realized via an algorithm that combines 3D single range camera position information with inertial sensor orientation data. The pose of each joint is described by a homogeneous transform (rotation matrix and translational vector) between world (single range camera) and joint frames. The rotation matrix is used to calculate joint error, whereas the translational vector is used to plot the joint coordinate frames at the proper location on the visual skeleton. Joint frames are shown during system testing only. The algorithms for measuring translation and rotation of torso and limbs are described, herein, below.

The translation vector from world frame, W, to joint frame, J, was measured directly by the single range camera and existing software in the form of x, y, and z joint coordinates:

^{W}T_{J}=[x_{Kinect} y_{Kinect} z_{Kinect}]^{T} (1)

The rotation of the torso frame with respect to the world frame was computed from the torso center P_{C}, neck P_{N}, and left shoulder P_{LS} skeleton points. It was assumed that the torso moved as a single plane connecting these points. The form of the torso rotation matrix was:

$$\begin{matrix}{}_{}^{W}{R}{}_{Torso}^{} = {[ \begin{matrix}{}_{}^{W}{\hat{X}}{}_{Torso}^{} & {}_{}^{W}{\hat{Y}}{}_{Torso}^{} & {}_{}^{W}{\hat{Z}}{}_{Torso}^{}\end{matrix} ]}^{T} \\ where & ( 2 ) \\ {}_{}^{W}{\hat{Y}}{}_{Torso}^{} = \frac{{P}_{N} - {P}_{C}}{‖ {P}_{N} - {P}_{C} ‖} & ( 3 ) \\ {}_{}^{W}{\hat{Z}}{}_{Torso}^{} = {}_{}^{W}{\hat{Y}}{}_{Torso}^{} \times \frac{P - {P}_{C}}{‖ {P}_{LS} - {P}_{C} ‖} & ( 4 ) \\ {}_{}^{W}{\hat{X}}{}_{Torso}^{} = {}_{}^{W}{\hat{Y}}{}_{Torso}^{} \times {}_{}^{W}{\hat{Z}}{}_{Torso}^{} & ( 5 )\end{matrix}$$

For both shoulder and elbow joints, the rotation of the joint frame with respect to the world frame, ^{W}R_{J}, was constructed from the multiplication of two rotation matrices individually derived from single range camera and inertial sensor data:

$$\begin{matrix}{}_{}^{W}{R}{}_{J}^{} = {\underbrace{{}_{}^{W}{R}{}_{ji}^{}}}_{Kinecs} {\underbrace{{}_{}^{Ji}{R}{}_{J}^{}}}_{Accelerometer} \\ where , & ( 6 ) \\ {}_{}^{W}{R}{}_{Ji}^{} = {R}_{x} ( θ ) {R}_{y} ( φ ) = [ \begin{matrix}c φ & 0 & s φ \\ s φ s θ & c θ & - c φ s θ \\ - s φ c θ & c θ & c φ c θ\end{matrix} ] & ( 7 ) \\ {}_{}^{Ji}{R}{}_{J}^{} = {R}_{z} ( ζ ) = [ \begin{matrix}c ζ & - s ζ & 0 \\ s ζ & c ζ & 0 \\ 0 & 0 & 1\end{matrix} ] & ( 8 )\end{matrix}$$

In this notation, W, J, and Jᵢ represent the world, joint, and joint intermediate frames, respectively, and cosine and sine functions are abbreviated as c and s, respectively. ^{W}R_{Ji} is defined by the rotations about the world X-axis by θ and about the world Y-axis by φ; ^{Ji}R_{J} describes rotation about the intermediate Z-axis by ζ. The Z-axis of the joint frame is constrained to be aligned with the limb axis, such that the Z-axis of the joint frame with respect to world frame, ^{W}Z_{J}, relates to the limb axis by the rotation, ^{W}R_{Ji}:

^{W}Z_{J}=^{W}R_{Ji} ^{Ji}Z_{J} (2)

Here, ^{W}Z_{J}=pₓ p_{y} p_{z}^{T} is the normalized vector from joint n to joint n+1 and ^{Ji}Z_{J}=0 0 1^{T} is the Z-axis of the joint frame n. Substitution of (7) in equation (9) yields the relationship between the position vector and the third column of the rotation matrix, ^{W}R_{Ji}:

$$[ \begin{matrix}{p}_{x} \\ {p}_{y} \\ {p}_{z}\end{matrix} ] = [ \begin{matrix}s φ \\ - c φ s θ \\ c φ c θ\end{matrix} ] \qquad ( 10 )$$

By equating the left and right sides of this equation, the equation can be sequentially solved for θ and φ:

θ=α tan 2(−py, pz) (11)

φ=α tan 2(cθpx, pz) (12)

Inertial sensor data was used to directly identify the last rotation angle, ζ. Given that the total acceleration is pointing downwards, in the −Y direction of the world frame, ^{W}A describes the magnitude of total acceleration in the world frame, defined as ^{W}A=0−A 0^{T}. The reading from the three-axis inertial sensor is the total acceleration written in the joint frame, ^{J}A. The two are related by the rotation from world to joint frame:

^{J}A=^{J}R_{w}^{W}A

(13)

Further, by expressing ^{J}R_{w} as (^{W}R_{J})^{T}, equation (13) becomes:

$$[ \begin{matrix}{a}_{x} \\ {a}_{y} \\ {a}_{z}\end{matrix} ] = {{R}_{z} ( ζ )}^{T} {{R}_{y} ( φ )}^{T} {{R}_{x} ( θ )}^{T} [ \begin{matrix}0 \\ - ‖ A ‖ \\ 0\end{matrix} ] \qquad ( 14 )$$

The measured acceleration data is then equated to the scaled rotation matrix column:

$$[ \begin{matrix}{a}_{x} \\ {a}_{y} \\ {a}_{z}\end{matrix} ] = [ \begin{matrix}s ζ c θ + c ζ s φ s θ \\ c ζ c θ - s ζ s φ s θ \\ - c φ s θ\end{matrix} ] \cdot ( - ‖ A ‖ ) \qquad ( 15 )$$

To solve for ζ:

ζ=α tan 2(cθαₓsφsθα_{y}, sφsθαₓ+cθα_{y}) (16)

Finally, the rotation matrix describing the world frame written in joint frame is calculated:

^{J}R_{w}=R_{z}(ζ)^{T}R_{y}(φ)^{T} Rₓ(θ)^{T} (17)

For every recorded time step, a frame is generated for each joint, including (1) torso, (2) right shoulder, (3) left shoulder, (4) right elbow, and (5) left elbow.

When a user is in a desired pose, a key press activates the recording of all joint frames. This recorded pose is assigned as the prior. For every future time step, comparisons are made between this prior and the current pose, denoted as the active. The joint angle error, ^{J}Rₑᵣᵣ, between prior and active frames is found for each joint:

$$\begin{matrix}{}_{}^{J}{R}{}_{err}^{} = {{}_{}^{J}{R}{}_{err}^{} ( {}_{}^{J}{\hat{R}}{}_{err}^{} )}^{- 1} \\ = {}_{}^{J}{R}{}_{W}^{} {}_{}^{W}{\hat{R}}{}_{J}^{}\end{matrix} \qquad \begin{matrix}( 18 ) \\ ( 19 )\end{matrix}$$

where, ^{J}Rₑᵣᵣ is the joint error, ^{J}R_{w} is the active joint frame, and ^{J}R_{w} is the prior joint frame. For the calculation of torso error:

^{J}Rₑᵣᵣ=^{Torso}R_{w}^{W} \hat{R}_{Torso} (20)

X-Y-Z fixed angles (γ, β, and α, respectively) are calculated directly from ^{J}Rₑᵣᵣ. For each time point when active is being compared to prior, a total of 15 angular errors are calculated.

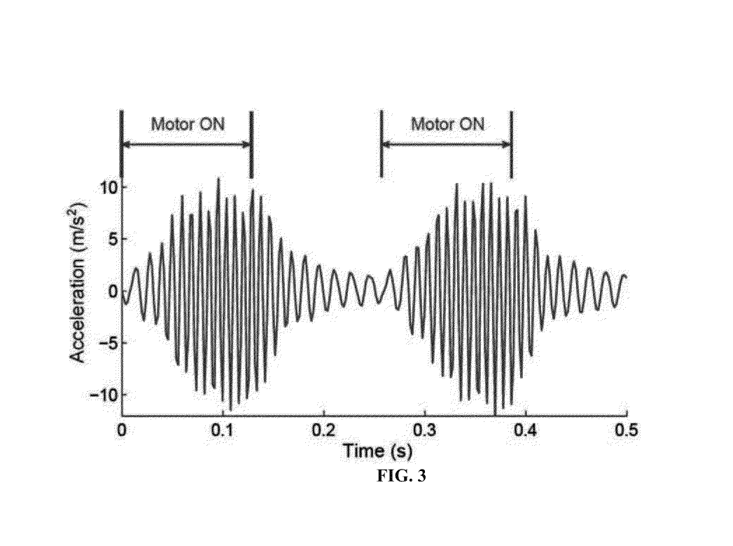

FIG. 3 illustrates a graph plotting acceleration over time for a single tactor response to a binary control signal, in accordance with an embodiment of the invention. FIG. 3 shows sample data of a single motor being pulsed on the wrist band, recorded from an external inertial sensor. The approximate period where the motor is commanded ON is indicated. The envelope frequency of vibration is 3.9 Hz with an amplitude of approximately ±1 g. An FFT of the vibration after transients decayed indicated a frequency of 117.2 Hz was felt by the user during pulsing. Pure motor vibration of constant amplitude yielded a higher vibration frequency of 162.2 Hz. Though the motor vibration is specified to be ±1.5 g at 210 Hz with 3.7V power, the difference in observed frequencies and amplitude may be attributed to non-rigid motor connection within band, damping effects of the arm, and spin-up/down time for the motor (92 ms and 116 ms, respectively).

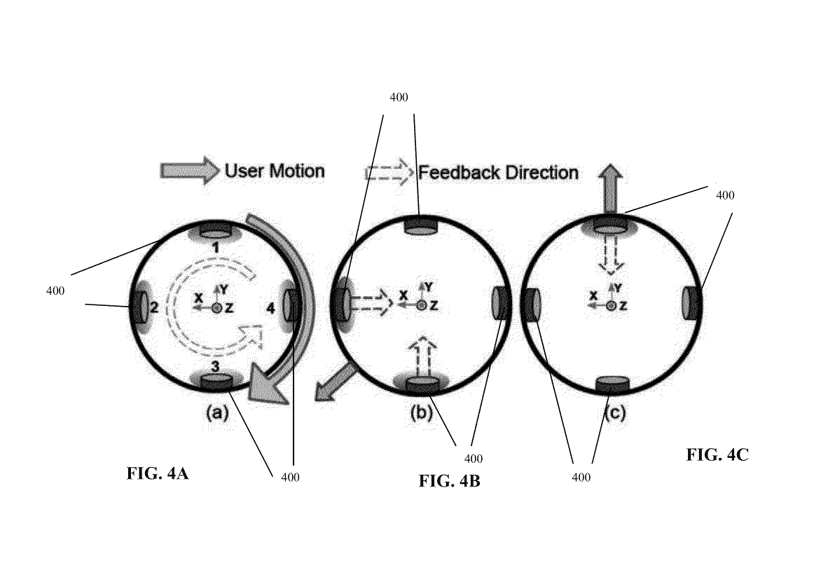

FIG. 4A illustrates an exemplary schematic of an armband for producing a vibrotactile feedback pattern for a user's joint misalignment about the Z-axis, in accordance with an embodiment of the invention. Joint error is displayed to the user through the vibration of shaftless eccentric mass motors 400. Motors 400 are mounted on the interior of each band in a quadrant pattern enabling spatial cues around the torso and limbs. While a quadrant pattern is shown in FIGS. 4A-C, any suitable patter can be used, so long as the placement of the motors is fixed with respect to the inertial sensor. A repulsive vibrotactle stimulus is used that “pushes” the user in the direction needed to correct the misalignment. The arm bands provide three different vibrotactile patterns for errors about the X, Y, and Z axes of the shoulder and elbow coordinate frames, as shown in FIGS. 4A-C. The appropriate pattern is chosen based on the axis of maximum error, calculated using the algorithms described above. As shown in FIG. 4A, when maximum error is a rotation about the Z-axis, motors 400 are activated in a clockwise (CW) or counterclockwise (CCW) sequence, against the direction of misalignment.

FIG. 4B illustrates an exemplary schematic of an armband for producing a vibrotactile feedback pattern for a user's joint misalignment about both the X-axis and the Y-axis, in accordance with an embodiment of the invention. As shown in FIG. 4B, when maximum error is about the X or Y axis and both X and Y errors are above threshold, two tactors are pulsed simultaneously, directing the user along a diagonal vector.

FIG. 4C illustrates an exemplary schematic of an armband for producing a vibrotactile feedback pattern for a user's joint misalignment about a single axis, the Y-axis, in accordance with an embodiment of the invention. As shown in FIG. 4C, a single maximum and above-threshold error about either X or Y axes, one tactor is pulsed in the direction of user error.

For both FIGS. 4B and 4C, motors were vibrated over a pulse period of 250 ms with 50% duty cycle. Pulsed vibration was selected to prevent Pacinian corpuscles that sense vibration on the skin from adapting to continuous stimuli, helping to preserve users' ability to localize the vibration. The motors on the torso band displayed rotational and single axis patterns similar to FIGS. 4A and 4C only, with the modified saltation presented at the same speed as the upper arm band.

With respect to FIGS. 4A-C, saltatory signals have been implemented to give the tactile illusion of traveling contact for rotational feedback with mixed success. This effect is elicited by pulsing a series of motors 3-6 times each with an interstimulus interval of 20-300 ms. Due to the rise time of the motor (approximately 90 ms) a modified signal was implemented in which each motor was fired once in succession, but with an added pause placed at the end of each rotational sequence. This break was meant to help the user distinguish directionality. The rotational speeds of pulsing around the arm were tailored to band location; upper arm bands featured a pattern with each motor ON for 145 ms with a 218 ms (1.5× ON) pause. Rotation presented for the forearm bands was slower, with motors ON for 200 ms followed by a 300 ms pause. Preferably, a slower speed of approximately 0.9 rot/s can be used to improve directionality recognition.

With respect to the potential for correction and the examples shown in FIGS. 4A-C, the system corrects misalignment of one (or two) DOF(s) for a single joint at a time with the largest magnitude of error. Correction in a serial fashion reduces the attentional demand on the user, compared to strategies that require the user to prioritize proportional vibration cues simultaneously delivered across multiple joints. Also, it allows the use of constant (versus proportional) vibration amplitude.

To identify a maximum error, each joint DOF is assigned a threshold value that creates a deadband for angular misalignment, specifying when a joint is close enough to the target position. Angular thresholds, shown in Table 1, below, ranged from ±3° for the highly sensitive torso to ±15° for shoulder rotation about Z. For each iteration of the control loop, all above-threshold joint errors are identified.

TABLE 1

| | Threshold (°) | | | Weight | | |
|---|---|---|---|---|---|---|
| Joint | X(γ) | Y(β) | Z(α) | X(γ) | Y(β) | Z(α) |
| 1 | 3 | 3 | 4 | 4.0 | 4.0 | 4.0 |
| 2 | 6 | 6 | 15 | 2.0 | 2.0 | 1.5 |
| 3 | 6 | 6 | 15 | 2.0 | 2.0 | 1.5 |
| 4 | 6 | 6 | 10 | 1.0 | 1.0 | 0.8 |
| 5 | 6 | 6 | 10 | 1.0 | 1.0 | 0.8 |

Joint errors are then weighted with respect to 1, allowing the prioritization of the correction of some joints over others. For the application of standing postural correction, preferably, trunk stability and proximal joint stability can be prioritized to maintain stability about the trunk and prioritize proximal joints. Torso errors are weighted most heavily by applying a scaling factor of 4. Shoulder error is prioritized over wrist error, and further, wrist errors about the X and Y axes are weighted more heavily compared to wrist rotation about Z. The weighted values of all above-threshold errors are sorted, and the maximum is defined.

The appropriate motor or sequence of motors, described above with respect to FIGS. 4A-C is then activated until the maximum error is corrected. Joint error data recorded while a user maintained a standing yoga pose, such as that illustrated in FIG. 1, with haptic feedback active validated the error correction algorithm.

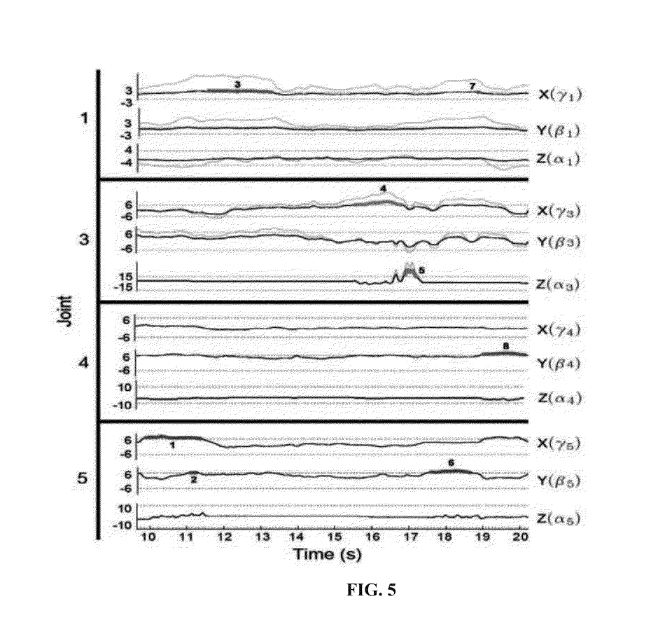

FIG. 5 illustrates a chart of numbered haptic feedback activations across four joints ordered over time, in accordance with an embodiment of the invention. A portion of the data over time is shown in FIG. 5. Error about X, Y, and Z axes is plotted for 4 joints (black lines). For each DOF, both angular thresholds (dashed lines) and weighted errors (gray lines) are displayed. Motor activation, shown by bold data segments, occurs serially, as numerical labels indicate. Aside from activations (1 and 2) that represent correction of a “diagonal” movement, each single error is brought within its threshold before the correction of a subsequent error begins.

### EXAMPLE 1

An experiment was performed to evaluate the accuracy of the combined single range camera and inertial sensor sensing by comparison to the Optotrak Certus optical tracking system (Northern Digital Inc., Waterloo, Canada). The Optotrak, widely used in research, provides 6-DOF sensing using bodymounted infrared LED markers and camera sensors. The system is accurate to within 0.1 mm, with a sensing resolution of 0.01 mm.

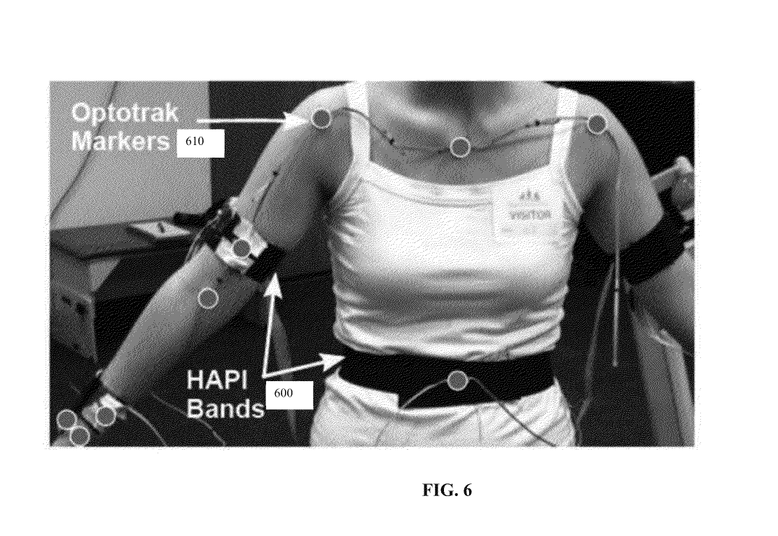

As illustrated in FIG. 6, in the experiment, a single user was fit with the bands system 600 and Optotrak markers (610) were placed at locations that corresponded to joints tracked by the single range camera. Marker placement is shown in FIG. 6. The user was asked to make single-DOF movements for each joint, while joint positions were simultaneously recorded using the present band system and Optotrak systems. For each recording, the user held an initial pose for 3 s, made a single-DOF angular movement, and held the final pose for 3 s. For the system, the relative angle between start and end position was calculated using the error algorithm previously described. The 3D position of markers tracked by the Optotrak were used in manual calculation of relative angular position, taken as the “ground truth” against which we measured sensing error in the system. Both relative position signals were aligned at the start of movement and the absolute difference in final angular position was taken as a measure of the system error for each DOF.

### EXAMPLE 2

A human user study of movement performance was also conducted with haptic feedback (H) in comparison to no feedback (N) and visual feedback (V). Subjects were trained on the present bands system and made targeted, single-DOF movements with the torso and arms across the three feedback modalities. The participants were 12 right-handed subjects (8 male and 4 female) between the ages of 22 and 41, with an average age of 27. To investigate the effect of hand dominance on movement performance, subjects were divided into two groups, each n=6, that performed arm movements using the dominant or non-dominant arm.

Prior to training, each subject was fit with the present bands system and positioned facing a visual display screen on which the single range camera was mounted, as shown in FIG. 2. Participants were instructed to explore haptic cues for each joint. Throughout training, subjects received visual feedback of their “skeleton.” Joint misalignment was indicated by the respective portion of the skeleton changing to red and returning to blue when the original pose had been restored. After training using each separate band, users practiced holding poses with all bands active. During training, joint error thresholds were kept constant for all subjects.

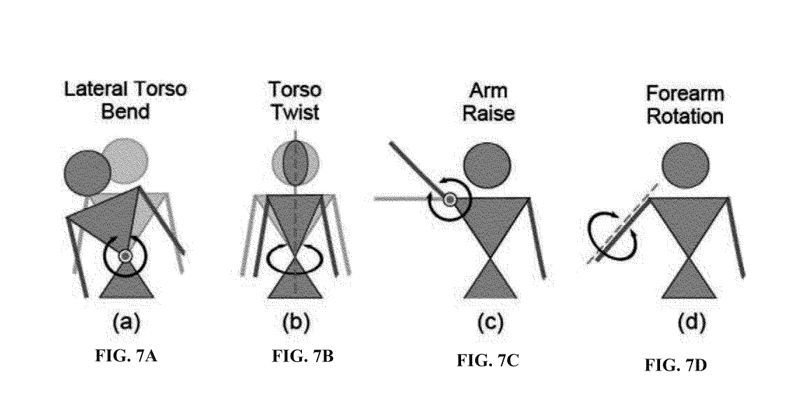

After training, subjects performed the experiment with the four 1-DOF movements indicated in FIGS. 7A-D. These movements were selected to test the effectiveness of haptic feedback in both single directional and rotational motions across appropriate joints. For each movement, a sequence of target learning and recorded trials was carried out. Subjects assumed the neutral position for the respective movement, indicated by the light gray skeleton in FIGS. 7A-D. From the neutral pose, subjects were directed towards four target positions including large and small angles in both positive and negative directions from neutral. Selected targets spanned the range motion for each joint. In the target learning phase only, a colored circle was shown on the screen to relay the subject's current position; a blue circle indicated that the subject was at the neutral position, a red circle indicated that the subject had moved away from neutral, and a green circle indicated acquisition of a target (subject within ±1.5°). Subjects were guided to each of the four targets from the neutral positions, and were asked to remember the target positions.

In the recorded trials, natural movements to each target were made in random order; movement recording was ended when the subject vocalized that he believed he had reached the target. This task was repeated across the three feedback conditions, presented in random order to counteract any learning effects:
N (No feedback): Haptic bands are worn with vibrotactile feedback passive. Visual display is completely covered.
V (Visual): Haptic bands are worn with vibrotactile feedback passive. Visual display screen shows the user's skeleton in blue with misaligned portions of the skeleton appearing in red until corrected.
H (Haptic): Haptic bands are worn with vibrotactile feedback active. Visual display is completely covered.

The procedure was repeated for each of the four movements with rest periods enforced to reduce fatigue. End-point error was measured for each trial. Error was computed as the absolute value of angular difference between current and target position at the end of movement and was averaged over the 4 targets. After trials, subjects completed a survey indicating the intuitiveness of the haptic feedback patterns and the comfort of the system.

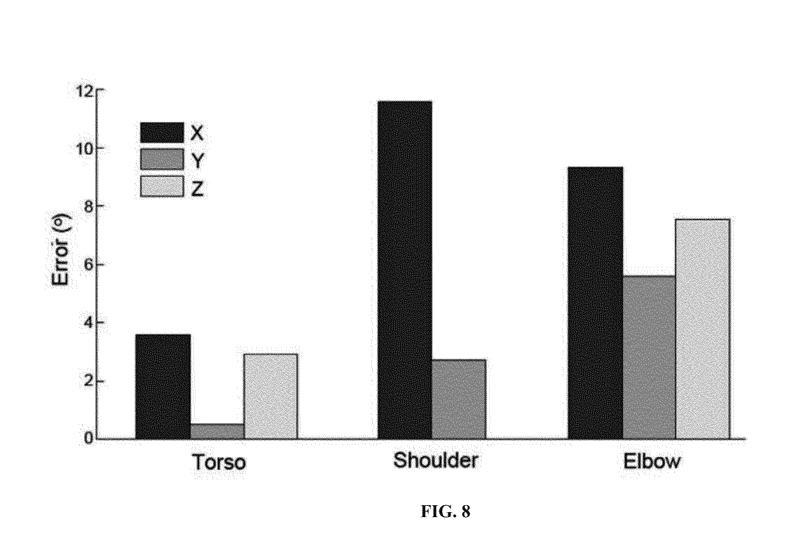

The sensing error of the system ranged from approximately 1° to 12°. FIG. 8 illustrates the breakdown of these errors based on joint and DOF. Sensing of torso movement was the most accurate, with an average error of 2.33°. Within this joint, the single range camera most accurately captured torso twist, with error of 0.50°. Errors in shoulder and elbow movements were larger, with averages of 7.13° and 7.48°, respectively. Error in shoulder rotation about Z-axis was not recorded, as this movement is captured within forearm rotation.

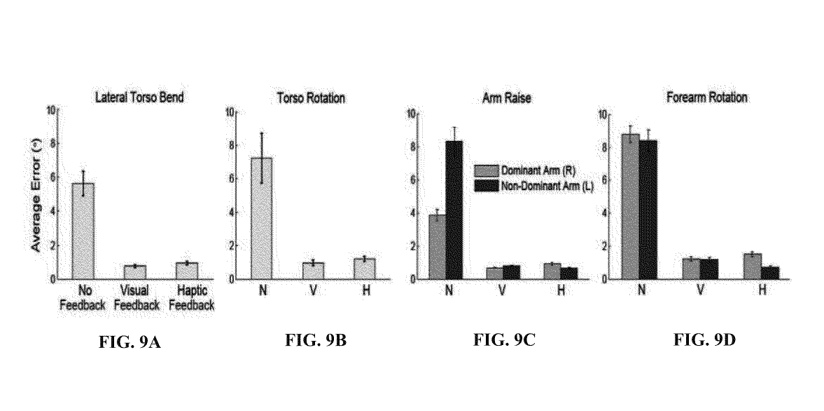

Plots of average error for each movement and feedback condition are shown in FIG. 9. For both torso bend and twist movements, error was analyzed using a within-subject ANOVA with feedback condition as a fixed factor (levels: N, V, and H) and subject as a random factor. To account for data violations of sphericity, Geisser and Greenhouse's ê adjustment was applied with significance at α=0.05.

Results for lateral torso bend (F(1.05; 11.60)=43.49; p=0.000026; \acute{ε}=0.5272) and torso twist (F(1.03; 11.34)=17:66; p=0:0013; \acute{ε}=0.5153), showed a significant difference in average error across feedback conditions. Torso movements made with N produced largest endpoint errors between approximately 5° and 10°.

Pairwise F-tests of group differences with Bonferroni adjustment (α_{Adj}=0.0167), confirmed that average errors for V and H conditions were significantly less than error with N. A two-tailed Student's t-test between average error for torso rotation and torso bend with H, indicated comparable performance of single-axis and rotational cues (p=0.121).

For arm movements, a mixed ANOVA test with \acute{ε} adjustment was done using arm group as the between-subjects factor (levels: dominant and non-dominant) and feedback condition as the within subjects factor. Both main effects and their interaction were statistically analyzed.

In arm raise, arm dominance (p=0.0365), feedback condition (p=0.0003), and their interaction (p=0.0294) were all significant factors influencing average endpoint error. To further measure degree of effect, \acute{ω}² was calculated for each factor, resulting in feedback condition having the greatest influence on data variance (\acute{ω}_{ond}=0.6182). FIGS. 9A-D show that the average error for subjects using their dominant arm was significantly less only in the N condition. In contrast, when forearm rotation was considered, only feedback condition was a significant factor. Based on graphical results and follow-up tests, both V and H feedback significantly reduced average error in both arm raise and forearm rotation movements.

Investigation of sensing accuracy showed that the system can most accurately capture torso movements as compared to shoulder and elbow movements. This difference in accuracy across joints may be explained by (1) inherent inertial sensor sensing limitations or (2) the method for computing relative joint angles using the Optotrak.

Torso position relies solely on the single range camera and vector computation, whereas shoulder and elbow measurements incorporate inertial sensor sensing that is susceptible to drift and dependent on limb position. While recorded movements were made with the arms stretched outwards to user's front or side, inertial sensor sensing breaks down as the arm approaches a vertical pose. When completely vertical, the gravity vector projects only on the longitudinal Z-axis of the arm, yielding too little information to determine orientation.

Potential alternatives for resolving inertial sensor error could involve more aggressive filtering or the implementation of an IMU which incorporates gyroscopes to determine rotation; the tradeoff is both higher cost and introduction of accumulated error.

More likely, discrepancy between single-range-camera-tracked body points and Optotrak marker locations lead to an offset or scaling error, especially in forearm rotation. The position of the “wrist” tracked by the single range camera actually can represent position localized within the point cloud of the hand. It is possible that the single range camera tracks a more distal position, compared to Optotrak wrist markers, resulting in further rotational misalignment. The Microsoft Kinect SDK (software development kit) that was released in July 2011 has the capability of tracking separate coordinates for the hand and wrist. Integrating this software in the next project iteration may resolve these accuracy flaws.

Further, in this initial test, error was based on a single recorded data point. More thorough investigation of error across multiple trials and movements that begin and end in the same position would better address both sensing accuracy and repeatability. For the application of postural correction, repeatability may be an important parameter, ensuring that the target pose remains constant in relation to the world frame over time. The Optotrak measurements may not be perfect, with a claimed accuracy of 0.1 mm.

With respect to human performance, the results of all single-DOF movements showed that without feedback, large errors are made across all joints, as users have imperfect proprioceptive memory of joint position. Users commented that without feedback, quick, but less accurate movements were made. The fact that haptic feedback was as effective as visual feedback in all movements indicates that in posture holding, where movement accuracy is a priority, the present bands system can be used as a substitute for visual feedback.

While endpoint error was the single metric under investigation in this study, user comments indicated a focus on the time-scale of response. With visual feedback the tendency was to “quickly overshoot the target and come back,” using visual cues for position refinement close to the target, but movements with haptic feedback were more “gradual and slow,” requiring users to wait for directional signals. Users felt that the haptic feedback introduced a delay in movement; one user suggested the presentation of a continuous vibration signal over pulsed vibration. These comments indicated that movement response time is another important variable for future exploration.

When rating intuitiveness of the haptic displays, users scored single-axis feedback at 8.8 out of 10, compared to 7.1 for rotational (saltatory) feedback. Responses for rotational feedback ranged from 4 to 10, indicating that some users found it very difficult to distinguish directionality (especially at the wrist), while others thought it was easy to follow. Large variance in user opinion suggests the need for tuning rotational speed to match individual sensitivity. While rotation was harder to learn for some, average error with rotational and single-axis haptic displays was comparable in torso movement, indicating user ability to adapt to rotational cues. Diagonal feedback about 2 axes was rated a 7.6, averaged across the 10 subjects that engaged this type of feedback. While the diagonal pattern had a favorable response, it was suggested that additional motors would improve the directional resolution of the feedback.

Arm dominance played a role only in arm raise error but not on forearm rotation error. Forearm rotation required only small angular deviations of the wrist, whereas arm raise required displacement of the whole arm mass which may trigger greater activation of joint sensors and proprioceptive cues. Within the arm raise movement, arm dominance improved error in the no feedback condition. This result contradicts previous studies that found no significant difference in proprioception between dominant and non-dominant shoulders for normal subjects. It is possible that “the added mass or the setup of the experiment” lead to this difference. When only haptic feedback was considered, arm dominance did not have a significant effect and vibrotactile cues are equivalently interpreted by both arms.

Improved accuracy and positive user-feedback in the human performance study suggest that the present bands system may be an effective tool in guiding pose. Subjects found the system to be favorable in terms of overall comfort (7.9) and ability to move without restriction (8.5). Future testing is planned to evaluate the effectiveness of haptic feedback in maintaining challenging user poses such as those required for yoga. Two considerations in the design of this study will be refinement of the error correction algorithm and implementation of directional based visual feedback. According to one user, haptic display for a single joint axis was frustrating when he got “stuck” trying to correct a single error despite the drift of other joints. This suggests an alternative correction scheme where joint errors may be corrected in groups. Presentation of grouped errors still reduces the high cognitive load required to attend to multiple joints at once. Secondly, in comparing the feedback modalities, visual feedback included only a color change to indicate joint misalignment, whereas haptic feedback included a directionality component that relayed how to move to correct error. According to post-training comments, visual feedback without such directionality was more difficult to interpret. In future studies, directional-based visual cues are necessary as a better comparison to vibrotactile feedback, perhaps in the form of a color-based paradigm.

The novel algorithm for the fusion of single range camera and inertial sensor sensing was implemented, found to be accurate for capturing torso, shoulder, and elbow joint rotation to within 4°, 12°, and 10°, respectively. In the scope of implementation, pose correction is most accurate when the wrist remains fixed and body segments remain un-occluded. Human performance testing indicated that haptic feedback was as effective in reducing targeting error as compared to movements made using visual feedback. Improved movement accuracy across all joints was observed using vibrotactile feedback.

The next step in system testing and design is investigating the effectiveness of haptic feedback in a pose-maintenance task. Though there are many potential applications for a posture-guidance system, a possible avenue for application-based testing will be instruction for yoga pose. Collaboration with yoga experts is already in progress.

The bands system can also be implemented as a full body wearable system that includes the legs and feet. Resolution of inertial sensor sensing limitations, integration of additional control hardware, and implementation of wireless solutions will guide the expansion of the system to the lower body. Haptic display will continue to be refined through the use of more sophisticated tactors and control that address the user feedback collected in this study. It is also possible, in a classroom learning environment, the single range camera's ability to simultaneously track both teacher and student in real-time, could be used to compare student's pose to that of a teacher's, instead of to his own prior.

While this system has been described for use with positions and postures, such as for yoga, it is possible that this system could be applied to provide motion capture and feedback numerous activities including but not limited to: sports, rehabilitation, dance, occupational therapy, physical therapy, entertainment, and gaming.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for motion capture of a user comprising:
a single range camera configured and positioned to collect data;
inertial sensors configured and positioned to collect inertial motion data;
a computer readable medium configured to analyze the data from the single range camera and the inertial motion data from the inertial sensors in order to determine a position of the user.

2. The system for motion capture of the user of claim 1, wherein the computer readable medium is further programmed to compare the position of the user to data for an exemplary position.

3. The system for motion capture of the user of claim 2, wherein the data for an exemplary position comprises data from one of a teacher also using the system for motion capture and predetermined data for the exemplary position stored on a computer readable medium.

4. The system for motion capture of the user of claim 3, wherein the computer readable medium is further programmed to provide a calculation of error between the position of the user and the data for the exemplary position.

5. The system for motion capture of the user of claim 4 further comprising a device for providing feedback to the user to correct the error between the position of the user and the data for the exemplary position.

6. The system for motion capture of the user of claim 5 wherein the device for providing feedback to the user comprises at least one of visual feedback, tactile feedback, vibrotactile feedback, and sound feedback.

7. The system for motion capture of claim 5 wherein the device for providing feedback to the user takes the form of an eccentric mass motor.

8. The system for motion capture of claim 1 wherein the inertial sensor takes the form of an accelerometer.

9. The system for motion capture of claim 8 wherein the accelerometer further takes the form of a 3-axis accelerometer.

10. The system for motion capture of claim 1 wherein the inertial sensor is positioned on a body part of the user for which it is to collect inertial motion data.

11. The system for motion capture of claim 1 wherein the inertial sensors are positioned to collect inertial motion data for a whole body of the user.

12. The system for motion capture of claim 1 wherein the inertial sensors are mounted in bands to allow the inertial sensors to be secured to the user.

13. The system for motion capture of claim 1 wherein the inertial sensors are positioned at a distal-most point of a limb-segment of the user.

14. The system for motion capture of claim 1 further comprising a visual display.

15. The system for motion capture of claim 14 wherein the visual display is further configured to show the user a visual representation of the user's movement.

16. The system for motion capture of claim 15 wherein the visual display is further configured to show the user a visual representation of the user's movement relative to an exemplary movement.

17. The system for motion capture of claim 1 further comprising a microcontroller.

18. The system for motion capture of claim 17 wherein the microcontroller is configured to control the inertial sensors as well as feedback to the user.

19. A method for motion capture of a user comprising:
collecting data related to the user's motion using a single range camera;
collecting inertial motion data for the user's motion; and
analyzing the data from the single range camera and the inertial motion data in order to determine a position of the user.

20. The method of claim 19 further comprising comparing the position of the user to data for an exemplary position.

21. The method of claim 20 further comprising calculating error between the position of the user and the data for the exemplary position

22. The method of claim 19 further comprising providing feedback to the user to correct the error between the position of the user and the data for the exemplary position.

23. The method of claim 19 further comprising providing visual feedback to the user.
